(19) United States
(12) Patent Application Publication
(10) Pub. No.: US 2017/0052642 A1
(43) Pub. Date: Feb. 23, 2017

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Hajime Sato, Yokohama-shi (JP)

(21) Appl. No.: 15/234,386

(22) Filed: Aug. 11, 2016

(30) Foreign Application Priority Data
Aug. 17, 2015 (JP) 2015-160601

(51) Int. Cl. G06F 3/041; G06F 3/042

(52) U.S. Cl. CPC G06F 3/0418; G06F 3/0425; G06F 2203/04107

(57) ABSTRACT

An information processing apparatus includes a display processing unit which displays a first point on a display screen of a display device, a first obtaining unit which obtains first coordinate data based on the first point displayed on the display screen by the display processing unit from coordinate input apparatuses having an overlap region in which coordinate detection regions of the coordinate input apparatuses overlap with each other, a second obtaining unit which obtains, when a second point is displayed in a position corresponding to the overlap region based on the first coordinate data, second coordinate data based on an instruction of the second point from the coordinate input apparatuses, and a positioning unit which performs positioning between a selection position and a display position in accordance with the first coordinate data and the second coordinate data.

### BACKGROUND OF THE INVENTION

Field of the Invention

The present disclosure generally relates to information processing and, more particularly, to an information processing apparatus, an information processing method, and a storage medium.

Description of the Related Art

Coordinate input apparatuses which control computers connected to the coordinate input apparatuses and write characters and graphics by inputting coordinates using a pointer (such as a dedicated input pen or a finger) on a coordinate input plane have been used. In general, as such a coordinate input apparatus, an electronic apparatus or an electronic system which performs display using an input unit, such as a touch panel, is widely used. A user interface using an application which allows an intuitive input operation by a touch input to a touch panel or the like has been developed. As a coordinate input method, a method using a resistive film and a method using light have been widely used, and a method for calculating a coordinate by detecting a light shielding position is referred to as a “light shielding method” hereinafter.

In a coordinate input apparatus employing the light shielding method, a coordinate input region may not be infinitely enlarged, and a light amount distribution in the extent that a designated positon of a shielding object included in the coordinate input region may be calculated is required to be obtained by a light receiving unit. A light amount is determined in accordance with luminous intensity in a portion which emits light, retroreflecting efficiency of a retroreflecting member, light receiving sensitivity of the light receiving unit, and the like. Accordingly, a size of one plane is determined by restriction of components included in the coordinate input apparatus. Therefore, as a practical system configuration for a large sized screen, a configuration in which systems of coordinate input apparatuses of one plane are combined so as to be arranged in a horizontal (or a vertical) direction so that a horizontally-long (or a vertically-long) scree in a large size is configured.

Japanese Patent No. 4913344 discloses a configuration in which, in a position input system including a plurality of touch apparatuses having overlap regions, a position of a pointer which moves astride a plurality of touch apparatus regions is tracked. In Japanese Patent No. 4913344, the overlap regions are processed in accordance with a predetermined logic (such as weighted average).

User interfaces which are operated when a display screen of a display device is touched are generally used in mobile terminals since anyone can intuitively use the user interfaces. Furthermore, even in apparatuses having a larger display screen, it is desirable that performance of such an operation is available. In such an electronic apparatus or the like using a touch input on a touch panel or the like, a target coordinate on a display screen and a coordinate detected when a touch input is performed on the target coordinate are shifted from each other (a coordinate shift) due to a shift of coordinates or the like. Therefore, in such a touch panel, before an operation of the touch panel, calibration is generally performed to transform a touch panel coordinate to a display coordinate of a display device. To correct such a coordinate shift, electronic apparatuses or the like include a so-called calibration menu. The user may correct the coordinate shift using the calibration menu. In the coordinate input apparatus employing optical light shielding method, a touch position is geometrically calculated based on light shielding directions (angles) of the touch position output from at least two sensor units and information on a distance between the sensor units. Therefore, the sensor units are required to be positioned with high accuracy so that the touch position is detected with high accuracy. However, in installment of the sensor units, accurate positioning may not be performed due to size variation of components or use environment, and consequently, a detection error is generated which causes a coordinate shift.

Furthermore, in a configuration in which a plurality of input planes are connected to one another so that a large input plane is obtained, a step or a coordinate shift is generated more or less in a joining region (an overlap region) in particular depending on coordinate calculation accuracy of the input planes in a case where input is performed astride the input planes. In the configuration in which a plurality of input planes are connected to one another as described above, a calibration operation is performed for each input plane, for example. Accordingly, in the case where a large screen is configured by a plurality of planes, the number of input points is naturally increased, and therefore, a burden of a user's operation is generated.

Furthermore, the calibration operation is performed before the apparatus is used, and in addition, is required to be performed again in a case where a projection position is shifted when projection is performed by a projector as a display device, for example. In the general calibration operation described above, a long period of time is required for resetting.

The present disclosure enables positioning between a selection position and a display position with ease while accuracy of a joining section (an overlap region) is maintained.

### SUMMARY OF THE INVENTION

According to an aspect of the present disclosure, an information processing apparatus includes a display processing unit configured to display a first point on a display screen of a display device, a first obtaining unit configured to obtain first coordinate data based on the first point displayed on the display screen by the display processing unit from a plurality of coordinate input apparatuses having an overlap region in which coordinate detection regions of the coordinate input apparatuses overlap with each other, a second obtaining unit configured to obtain, in a case where a second point is displayed in a position corresponding to the overlap region on the display screen by the display processing unit based on the first coordinate data, second coordinate data in accordance with an instruction of the second point from the plurality of coordinate input apparatuses, and a positioning unit configured to perform positioning between a selection position and a display position in accordance with the first coordinate data and the second coordinate data.

Further features of the present disclosure will become apparent from the following description of exemplary embodiments with reference to the attached drawings.

### BRIEF DESCRIPTION OF THE DRAWINGS

FIG. 1 is a diagram schematically illustrating a configuration of a system.

FIGS. 2A and 2B are diagrams illustrating a configuration of a sensor unit in detail.

FIG. 3 is a cross-sectional view of a coordinate input apparatus.

FIG. 4 is a diagram illustrating a control/calculation unit.

FIG. 5 is a timing chart of control signals.

FIG. 6 is a diagram illustrating a light amount distribution detected by the sensor unit (part 1).

FIG. 7 is a diagram illustrating a light amount distribution detected by the sensor unit (part 2).

FIG. 8 is a diagram illustrating a light amount distribution detected by the sensor unit (part 3).

FIGS. 9A to 9D are diagrams illustrating coordinate detection ranges.

FIG. 10 is a diagram illustrating the positional relationship with a screen coordinate.

FIG. 11 is a flowchart illustrating information processing performed by the coordinate input apparatus.

FIGS. 12A to 12C are diagrams schematically illustrating coordinate systems of coordinate input apparatuses.

FIG. 13 is a diagram schematically illustrating a case where coordinate input regions are arranged such that overlap regions are formed.

FIG. 14 is a diagram schematically illustrating a display coordinate system displayed in a display device.

FIG. 15 is a diagram illustrating a hardware configuration of a PC.

FIG. 16 is a diagram illustrating first and second steps of a calibration process (part 1).

FIG. 17 is a diagram illustrating the first and second steps of the calibration process (part 2).

FIG. 18 is a diagram illustrating a calculation of calibration points 5 to 8.

FIG. 19 is a flowchart illustrating information processing performed by the PC.

FIG. 20 is a diagram illustrating a configuration of a system according to a second embodiment.

FIG. 21 is a diagram illustrating an averaging process according to a third embodiment.

### DESCRIPTION OF THE EMBODIMENTS

Embodiments of the present disclosure will be described hereinafter with reference to the accompanying drawings.

### First Embodiment

### System Configuration

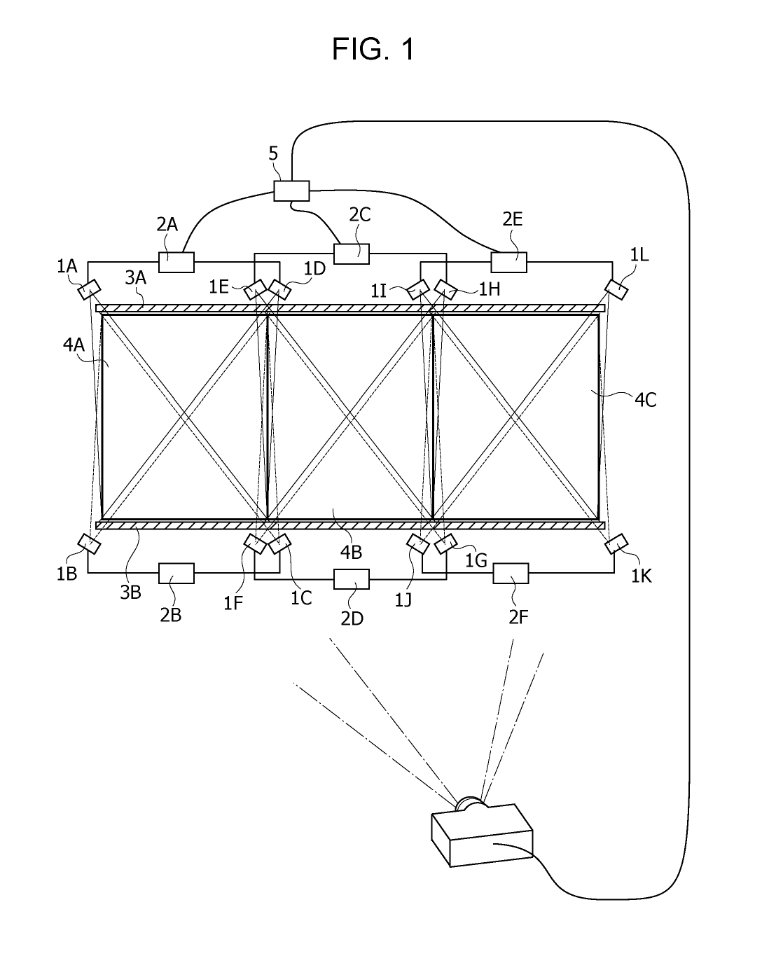

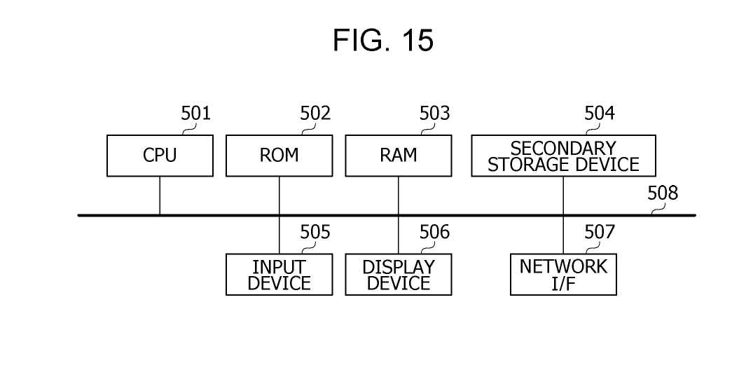

A configuration of a system is schematically described with reference to FIG. 1. As illustrated in FIG. 1, the system of this embodiment includes a plurality of coordinate input apparatuses and a personal computer (PC) 5 serving as an information processing apparatus which are communicatively connected to each other in a communication available manner. In FIG. 1, a projector serving as a display device 506 (described below; see FIG. 15) is connected to the PC 5.

In FIG. 1, each of sensor units 1A to 1D, 1E to 1H, and 1I to 1L (hereinafter collectively referred to as “sensor units 1”) includes a light projecting unit and a light receiving unit, and the sensor units 1A to 1D, 1E to 1H, and 1I to 1L are disposed with certain intervals. Each of control/calculation units 2A to 2F (hereinafter collectively referred to as control/calculation units 2) which perform control and calculation is connected to two of the sensor units 1. Each of the sensor units 1 receives a control signal from the control/calculation units 2 and transmits a detected signal to the control/calculation units 2. As used herein, the term “unit” generally refers to any combination of hardware, firmware, software or other component, such as circuitry, that is used to effectuate a purpose.

Each of retroreflecting units 3A and 3B (hereinafter collectively referred to as retroreflecting units 3) has a retroreflecting surface which reflects incident light in a direction in which the light is incoming and recursively reflects light emitted from the sensor units 1 back to the sensor units 1. The reflected light is detected in one-dimensional manner by detection units of the sensor units 1 each of which includes a light collection optical system, a line charge-coupled device (CCD) sensor, and the like, and a light amount distribution thereof is supplied to the control/calculation units 2.

Coordinate input regions 4A to 4C (hereinafter collectively referred to as coordinate input regions 4) accept input of coordinates performed by a user. The coordinate input region 4A is detected by the sensor units 1A to 1D, the coordinate input region 4B is similarly detected by the sensor units 1E to 1H, and the coordinate input region 4C is similarly detected by the sensor units 1I to 1L.

In this embodiment, the retroreflecting units 3 are formed on opposite sides of the coordinate input regions 4. The sensor units 1A, 1D, 1E, 1H, 1I, and 1L receive light projected to the retroreflecting unit 3B which is one of the retroreflecting units 3 on the opposite sides. Similarly, the sensor units 1B, 1C, 1F, 1G, 1J, and 1K receive light projected to the retroreflecting unit 3A which is the other of the retroreflecting units 3. In the example of the coordinate input apparatuses of FIG. 1, the coordinate input regions 4 are formed such that three planes are arranged adjacent to each other without gap, and the sensor units 1 to be used to calculate coordinates in the coordinate input regions 4 are disposed outside the coordinate input regions 4.

The coordinate input regions 4A to 4C are formed on a display screen of a display device, such as a plasma display panel (PDP), a rear projector, a liquid crystal display (LCD) panel, or the like, and an image is projected by a front projector, so that the coordinate input regions 4A to 4C may be used as interactive coordinate input apparatuses.

With this configuration, when an input instruction is performed by a finger or the like on the coordinate input regions 4, light projected from the light projecting units is blocked, and therefore, reflection light to be generated by retroreflection may not be obtained, and accordingly, a light amount only in an input instruction position may not be obtained.

Each of the control/calculation units 2 includes a communication unit which performs bidirectional communication. The control/calculation units 2 detect a light shielding range of a portion subjected to the input instruction in accordance with changes of light amounts of the sensor units 1A to 1L, specify detection points in the light shielding range, and calculate angles of the detection points. The control/calculation units 2 calculate coordinate positions in an input area in accordance with the calculated angles and distances between the sensor units 1 and output coordinate values to the PC 5 connected to the display device through interfaces, such as universal serial buses (USBs).

In this way, the PC 5 may be operated by rendering a line on the screen and by operating an icon by a finger.

Each section will be described in detail hereinafter. Sensor Units

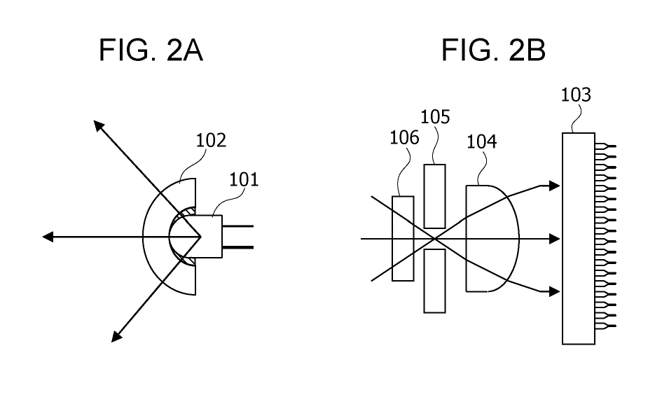

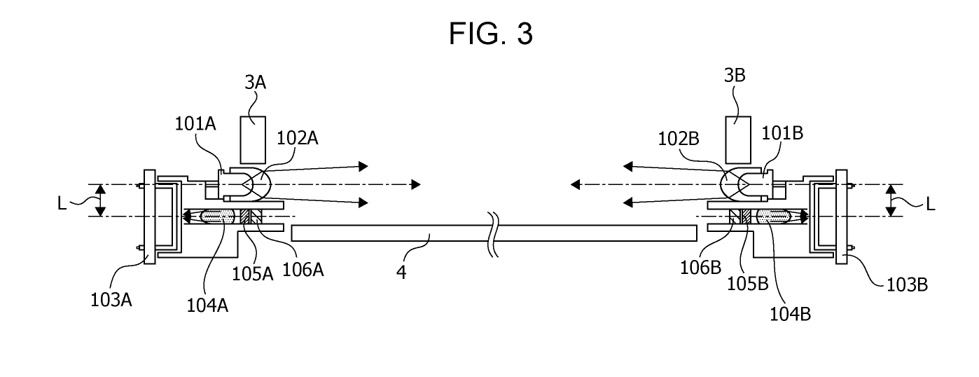

Next, a configuration of the sensor units 1A to 1L will be described with reference to FIGS. 2A, 2B and 3. Each of the sensor units 1A to 1L mainly includes a light projecting unit and a light receiving unit.

FIGS. 2A, 2B and 3 are diagrams illustrating a configuration of the sensor units 1 in detail.

In FIGS. 2A and 2B, an infrared light emitting diode (LED) 101 emits infrared light through a light projection lens 102 to the retroreflecting units 3 in a certain range. The light projecting unit included in each of the sensor units 1A to 1L is realized by the infrared LED 101 and the light projection lens 102.

The infrared light projected by the light projecting units is recursively reflected by the retroreflecting units 3 in a direction in which the light is incoming, and the light receiving units included in the sensor units 1A to 1L detect the light.

Each of the light receiving units includes a line CCD sensor 103 which is a one-dimensional line sensor, a light receiving lens 104 serving as a light collection optical system, a diaphragm 105 which roughly restricts an incoming direction of incident light, and an infrared filter 106 which prevents unnecessary light (ambient light), such as visible light, from being incident on.

The light reflected by the retroreflecting units 3 is collected on a detection element plane of the line CCD sensor 103 by the light receiving lens 104 through the infrared filter 106 and the diaphragm 105.

FIG. 3 is a cross-sectional view viewed from a side of the sensor units 1A and 1B. Light emitted from an infrared LED 101A of the sensor unit 1A is light flux restricted to be emitted substantially in parallel to a coordinate input plane which is mainly projected on the retroreflecting unit 3B by a light projection lens 102A. Similarly, light emitted from an infrared LED 101B of the sensor unit 1B is mainly projected on the retroreflecting unit 3A by a light projection lens 102B.

Here, in this embodiment, the light projecting unit and the light receiving unit are overlapped with each other in a direction which is orthogonal to the coordinate input regions 4 serving as a coordinate input plane. Then, a light emission center of the light projecting unit and a reference position of the light receiving unit (corresponding to a reference point position for measurement of an angle, that is, a position of the diaphragm 105 in this embodiment) match each other when viewed from the front (a vertical direction relative to the coordinate input plane).

Furthermore, light flux which is projected by the light projecting unit, which is substantially parallel to the coordinate input plane, and which is projected toward the coordinate input plane at a certain angle is recursively reflected by the retroreflecting units 3 in a direction in which the light is incoming. Then, the light is collected on the detection element plane of the line charge-coupled device (CCD) sensor 103A (103B) through an infrared filter 106A (106B), a diaphragm 105A (105B), and a light receiving lens 104A (104B) so as to form an image on the detection element plane.

Accordingly, a light amount distribution corresponding to an incident angle of the reflection light is output as a CCD output signal, and therefore, pixel numbers of pixels included in the line CCD sensor 103 indicate angle information. A distance L between the light projecting unit and the light receiving unit illustrated in FIG. 3 is sufficiently small when compared with a distance between the light projecting unit and the retroreflecting units 3, and the light receiving unit is capable of detecting sufficient retroreflecting light irrespective of the presence of the distance L.

In FIG. 3, the sensor units 1A and 1B are illustrated. A pair of sensor units 1E and 1F, a pair of sensor units 1D and 1C, a pair of sensor units 1H and 1G, and a pair of sensor unit 1L and 1K have the same configuration as the pair of sensor units 1A and 1B.

As described above, each of the sensor units 1A to 1L includes the light projecting unit and the light receiving unit which detects light projected by the light projecting unit.

### Control/Calculation Unit

A CCD control signal, a CCD clock signal, a CCD output signal, and an LED driving signal are transmitted and received between the control/calculation units 2A to 2F and the sensor units 1A to 1L illustrated in FIG. 1. The control/calculation unit 2A is connected to the sensor units 1A and 1D. Similarly, the control/calculation unit 2B is connected to the sensor units 1B and 1C. The control/calculation unit 2C is connected to the sensor units 1E and 1H. The control/calculation unit 2D is connected to the sensor units 1F and 1G. The control/calculation unit 2E is connected to the sensor units 1I and 1L. The control/calculation unit 2F is connected to the sensor units 1J and 1K.

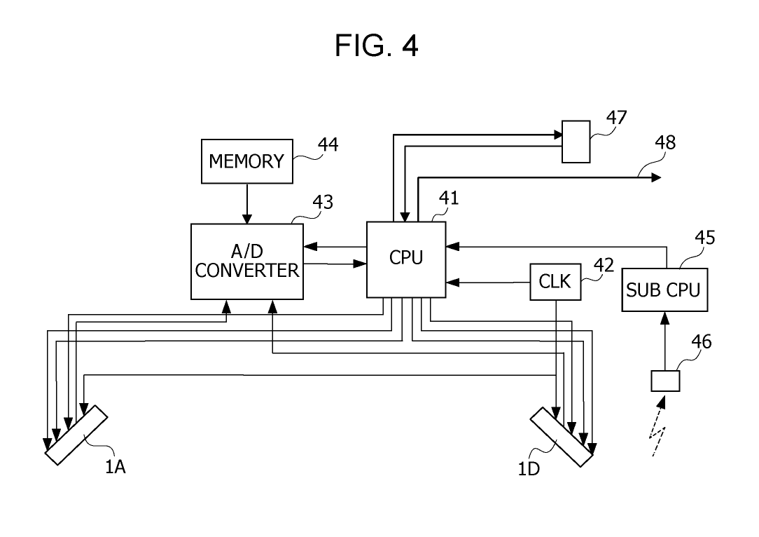

FIG. 4 is a diagram illustrating one of the control/calculation units 2. Although a configuration of the control/calculation unit 2A connected to the sensor units 1A and 1D is illustrated in FIG. 4, for example, the control/calculation units 2A to 2F have the same circuit configuration.

A CCD control signal is output from a central processing unit (CPU) 41 constituted by a component such as a one-chip microcomputer, and may include one or more processors and one or more memories. The CPU 41 outputs the CCD control signal so as to control a shutter timing of the line CCD sensor 103 and output of data. The CCD clock signal is transmitted from a clock generation circuit CLK 42 to the sensor units 1 and also input to the CPU 41 so that various control is performed in synchronization with the CCD sensor 103. The LED driving signal is supplied from the CPU 41 to the infrared LEDs 101 of the sensor units 1A and 1D.

Detection signals output from the CCD sensors 103 which are detection units of the sensor units 1A and 1D are supplied to an analog to digital (A/D) converter 43 of the control/calculation unit 2A and converted into digital values under control of the CPU 41. The converted digital values are stored in a memory 44 and used for an angle calculation. Coordinate values are obtained from the calculated angles and are output to the PC 5 or the like through a communication interface, such as a serial interface 48. The serial interface 48 of at least one of the control/calculation units 2A to 2F is connected to the PC 5.

Here, as illustrated in FIG. 1, the sensor units 1 and the control/calculation units 2 are separately arranged in upper and lower portions in this embodiment. Furthermore, in each of the upper and lower portions of the coordinate input regions 4A to 4C, each of the sensor units 1 which detect coordinates in the coordinate input regions 4A to 4C is connected to one of the control/calculation units 2.

First, a communication between the control/calculation units 2 in each of the upper and lower portions is performed through an interface 47 constituted by a wired serial communication unit or the like. Furthermore, control signals of the sensor units 1A, 1D, 1E, 1H, and 1L in the upper portion and control signals of the sensor units 1B, 1C, 1F, 1G, and 1K in the lower portion are synchronized with one another through the interface 47. Furthermore, various data stored in the memory 44 is transmitted and received through the interface 47.

Furthermore, a wireless communication unit is used for a communication between the control/calculation units 2 in the upper portion and the control/calculation units 2 in the lower portion. In this embodiment, communications between the control/calculation units 2 are performed through infrared communication interfaces 46 using data processed by sub CPUs 45.

The control/calculation units 2A to 2F are operated by master/slave control. In this embodiment, the control/calculation units 2A, 2C, and 2E are masters and the other control/calculation units 2B, 2D, and 2F are slaves. Each of the control/calculation units 2 may serve as a master and a slave, and switching between the master and the slave may be performed by inputting a switching signal to a port of the CPU 41 using a digital image processing (DIP) switch or the like.

The master control/calculation units 2A, 2C, and 2E supply control signals which control timings of transmissions of control signals of the sensor units 1 to the slave control/calculation units 2 through the interfaces 47. Then coordinate values are calculated in accordance with the procedure described above, and are transmitted to the information processing apparatus, such as the PC 5.

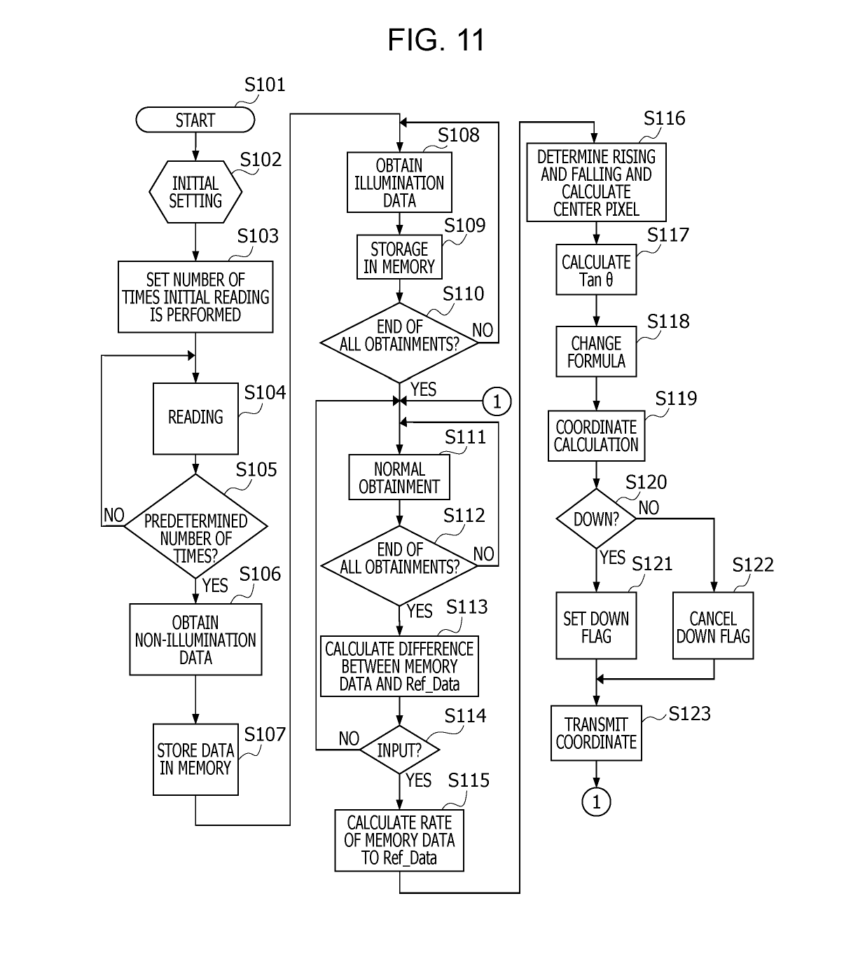

The CPU 41 executes a process in accordance with a program stored in the memory 44 or the like so as to realize functions of the control/calculation unit 2, a process of a flowchart in FIG. 11 described below, and the like.

### Light Amount Distribution

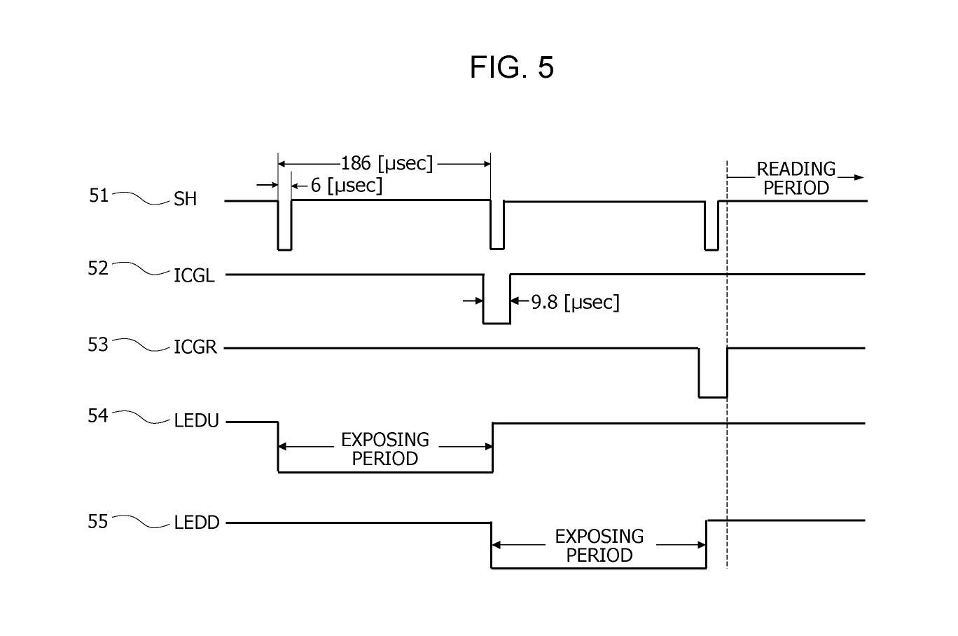

FIG. 5 is a timing chart of control signals.

Control signals 51, 52, and 53 are used to control the line CCD sensor 103. A shutter opening time of the line CCD sensor 103 is determined at an interval of the SH signal 51. The control signals 52 and 53 are gate signals supplied to the upper portion sensor units 1 (the sensor units 1A, 1D, 1E, 1H, 1I, and 1L) and the lower portion sensor units 1 (the sensor units 1B, 1C, 1F, 1G, 1J, and 1K), respectively. The control signals 52 and 53 are used to transfer a charge of a photoelectric conversion unit included in the CCD sensor 103 to a reading unit.

Driving signals 54 and 55 are used to drive the LED 101. The driving signal 54 is supplied to the LEDs 101 through driving circuits so that the LEDs 101 of the upper portion sensor units 1 are turned on in a first cycle of the SH signal 51. The driving signal 55 is supplied to the LEDs 101 of the lower portion sensor units 1 in a next cycle so that the LEDs 101 are driven. After the driving of the LEDs 101 in both of the upper and lower portions is terminated, signals of the CCD sensors 103 are read from the CCD sensors 103. Accordingly, after the upper and lower sensor units 1 project light at different timings which are different between the upper portion and the lower portion, a plurality of data of light (light amount distributions) received by the CCD sensors 103 are read.

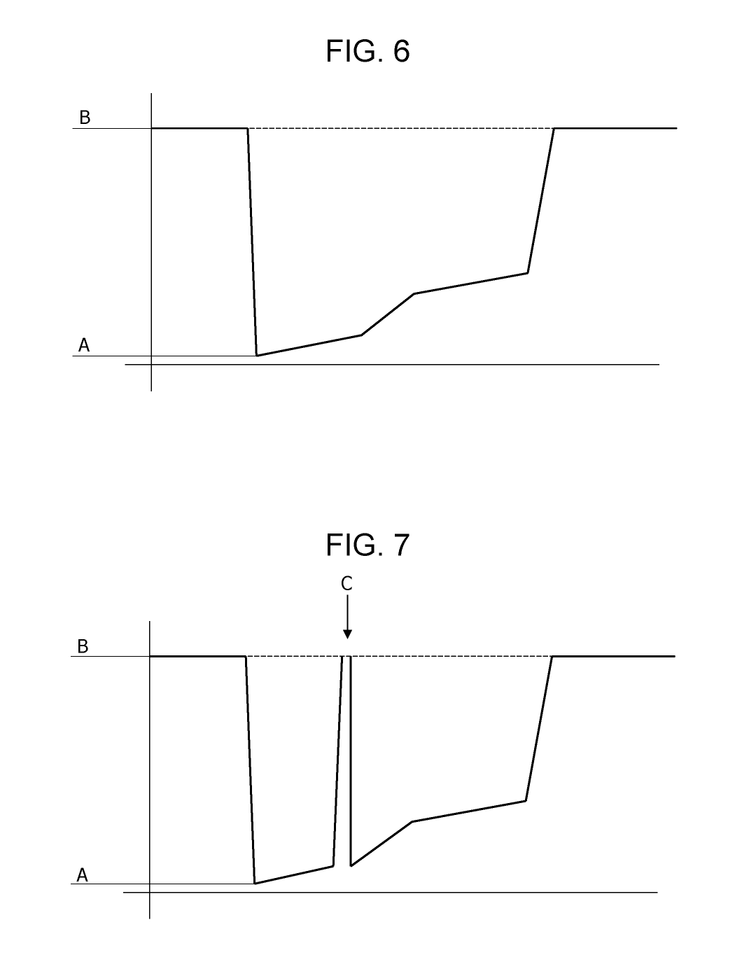

The read signals correspond to outputs from the sensor units 1 if input is not performed, and a light amount distribution illustrated in FIG. 6 is obtained. It is not necessarily the case that such a distribution is obtained in any system, and various distributions are obtained depending on a characteristic of a retroreflecting sheet, a characteristic of an LED, or aging variation (dirt in the reflection plane or the like).

In FIG. 6, an A level indicates a maximum light amount and a B level indicates a minimum light amount. Specifically, in a state of no reflection light, a level of an obtained light amount is approximately the B level, and as an amount of reflection light is increased, a level rises toward the A level. As described above, data output from the CCD sensor 103 is successively subjected to A/D conversion and obtained by the CPU 41 as digital data.

FIG. 7 is a diagram illustrating an output obtained in a case where input is performed by a finger or the like, that is, a case where reflection light is blocked. A light amount is reduced only in a C portion since reflection light is blocked by the finger or the like in the C portion. The CPU 41 detects input performed by the finger or the like with reference to the change of a light amount distribution.

More specifically, the CPU 41 stores an initial state in which input is not yet performed as illustrated in FIG. 6 in advance, determines whether a change as illustrated in FIG. 7 is detected in a sample period by obtaining a difference between a current state and the initial state, and performs, if a change is detected, a calculation of determining an input angle using a portion of the change as an input point.

### Angle Calculation

In angle calculation, first, the CPU 41 uses detection of a light shielding range.

Since a light amount distribution is not stable as time advances as described above, the light amount distribution is preferably stored when the system is activated, for example. By this, even if dust or the like adheres to the retroreflecting plane, for example, the retroreflecting plane is usable unless otherwise the retroreflecting plane reflects no light.

Although data of one sensor will be described hereinafter, similar processes are performed by the other sensors. When power is on and input is not performed, the CPU 41 performs A/D conversion on an output of the CCD sensor 103 in a state in which the light projecting unit does not emit light, and stores resultant data Bas_Data[N] in the memory 44. The data includes variation of a bias of the CCD sensor 103 and approximately has the B level of FIG. 6. Here, “N” denotes a pixel number, and a pixel number included in an effective input range is used.

Next, the CPU 41 stores a light amount distribution obtained in a state in which the light projecting unit projects light. The light amount distribution is data indicated by a solid line in FIG. 6 and denoted by “Ref_Data[N]”.

The CPU 41 determines whether input is performed using these data and determines whether a light shielding range exists. The CPU 41 determines data in a certain sampling period as Norm_Data[N].

The CPU 41 determines whether a light shielding range exists in accordance with an amount of change of data so as to specify the light shielding range. This determination is performed to prevent false determination caused by noise or the like and reliably detect a certain amount of change.

The CPU 41 performs calculation of change amounts below on individual pixels and compares the change amounts with a threshold value Vtha determined in advance.

Norm_Data[N]=Norm_Data[N]−Ref_Data[N] Expression 1

Here, “Norm_Data[N]” denotes a change amount in each pixel.

Since only a difference is obtained by comparison in this process, only a short processing time is used, and accordingly, the determination as to whether input has been performed may be performed at high speed. The CPU 41 determines that input has been performed when the number of pixels having change amounts which exceed the threshold value Vtha for the first time exceeds a predetermined number.

Subsequently, the CPU 41 calculates a change rate and determines an input point for high accuracy detection.

Norm_Data[N]=Norm_Data[N]/(Bas_Data[N]−Ref_Data[N]) Expression 2

The CPU 41 employs a threshold value Vthr for this data and obtains an angle by determining a center of pixel numbers of a rising portion and a falling portion as an input pixel.

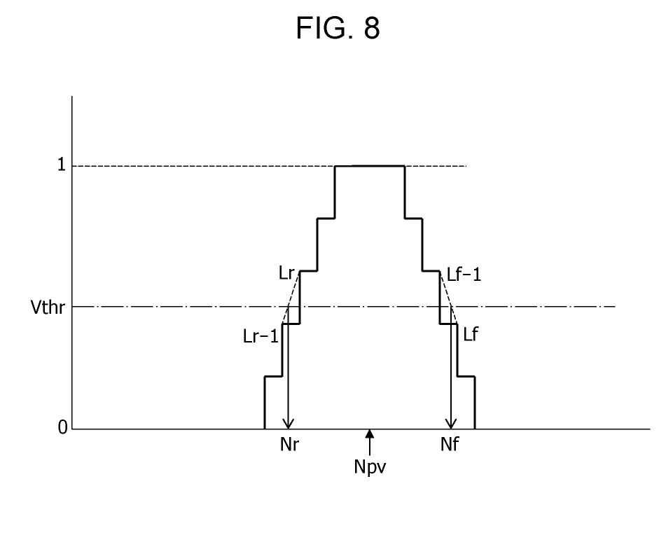

FIG. 8 is a diagram illustrating a detection performed after the calculation of a rate is performed. It is assumed that the threshold value Vthr is used for the detection and the threshold value Vthr is exceeded in an Nr-th pixel in the rising portion of the light shielding region. Furthermore, it is assumed that the value becomes smaller than the threshold value Vthr in an Nf-th pixel.

The CPU 41 may calculate a center pixel Np in accordance with Expression 3 below.

Np=Nr+(Nf−Nr)/2 Expression (3)

However, in this case, a pixel interval corresponds to a minimum resolution. To perform the detection more precisely, the CPU 41 calculates a virtual pixel number which across the threshold value using levels of pixels and levels of preceding pixels.

It is assumed that a level of the Nr-th pixel is denoted by “Lr” and a level of an (Nr−1)th pixel is denoted by “Lr−1”. Furthermore, assuming that a level of the Nf-th pixel is denoted by “Lf” and a level of an (Nf−1)th pixel is denoted by “Lf−1”, virtual pixel numbers Nry and Nfv are calculated by Expressions 4 and 5 below.

Nrv=Nr−1+(Vthr−Lr−1)/(Lr−Lr−1) Expression 4

Nfv=Nf−1+(Vthr−Lf−1)/(Lf−Lf−1) Expression 5

The virtual center pixel Npv is determined in accordance with Expression 6 below.

Npv=Nrv+(Nfv−Nrv)/2 Expression 6

In this way, since the virtual pixel number is calculated using the pixel numbers and the levels of the pixels, the detection may be performed with high resolution.

To calculate an actual coordinate value from the center pixel number obtained as described above, conversion into angle information is performed.

In an actual coordinate calculation described below, an obtainment of a value of tangent of an angle is preferably performed rather than an obtainment of the angle itself. To convert a pixel number into tan θ, the CPU 41 uses table reference and a conversion formula.

The CPU 41 may ensure accuracy by using a high-order polynomial as a conversion formula, for example. Meanwhile, the CPU 41 determines an order or the like taking calculation capability, accuracy spec, and the like into consideration.

In a case where a fifth-order polynomial is used, six coefficients are used, and therefore, data indicating that six coefficients is stored in a nonvolatile memory before shipping. Assuming that coefficients of a fifth-order polynomial are denoted by “L5”, “L4”, “L3”, “L2”, “L1”, and “L0”, tan θ is represented by Expression 7 below.

tan θ=((((L5*Npr+L4)*Npr+L3)*Npr+L2)*Npr+L1)*Npr+L0 Expression 7

When the same process is performed on the individual CCD sensors 103, angle data of the individual CCD sensors 103 may be determined. Although tan θ is obtained in the foregoing example, the CPU 41 may obtain an angle itself and thereafter obtain tan θ.

### Coordinate Calculation Method

The CPU 41 calculates a coordinate using the obtained angle data.

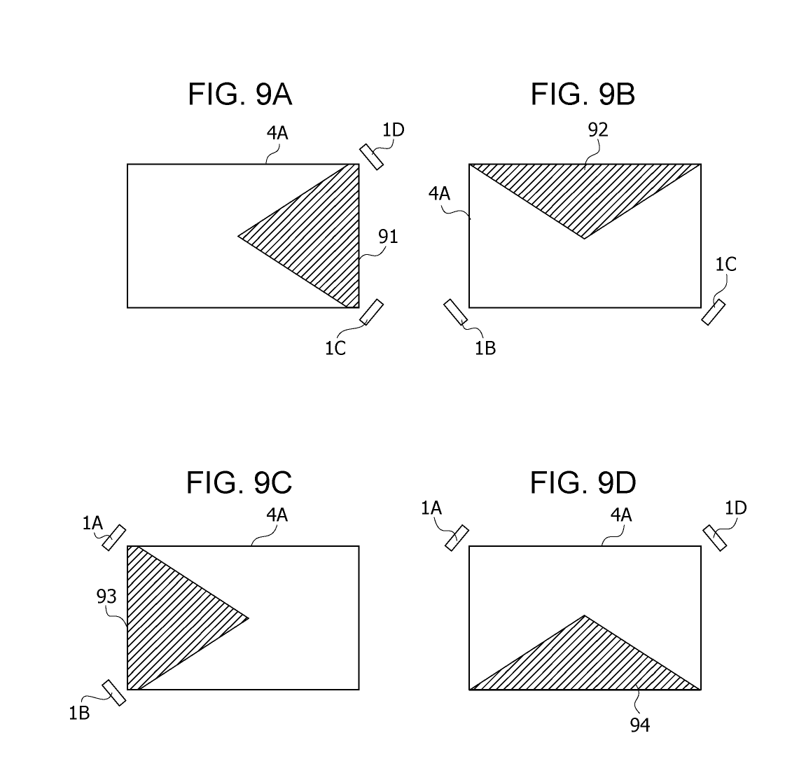

FIGS. 9A to 9D are diagrams illustrating coordinate detection ranges of the coordinate input region 4A on which a coordinate calculation may be performed by combining the sensor units 1.

As illustrated in FIGS. 9A to 9D, a region in which a light projecting range and a light receiving range of the sensor units 1 overlap with each other corresponds to a coordinate calculation available range. Therefore, a coordinate calculation available range obtained using the sensor units 1C and 1D is a range 91 denoted by hatched lines in FIG. 9A. Similarly, a coordinate calculation available range obtained using the sensor units 1B and 1C is a range 92 denoted by hatched lines in FIG. 9B, a coordinate calculation available range obtained using the sensor units 1A and 1B is a range 93 denoted by hatched lines in FIG. 9C, and a coordinate calculation available range obtained using the sensor units 1A and 1D is a range 94 denoted by hatched lines in FIG. 9D.

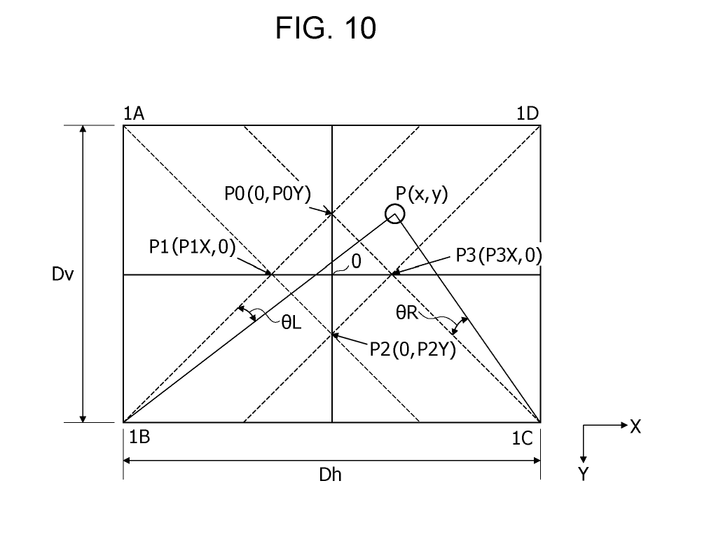

FIG. 10 is a diagram illustrating the positional relationship with screen coordinates. It is assumed that, in a case where input is detected in a position of a point P, light shielding data is detected by the sensor units 1B and 1C.

A distance between the sensor units 1B and 1C is denoted by “Dh”. Furthermore, a center of a screen is an origin position of the screen. “P0(0, P0Y)” denotes an intersection between the sensor units 1B and 1C at an angle 0. The angle 0 indicates a light projection direction of each of the sensor units 1 from a center of a light projection available range. The CPU 41 calculates tan θL and tan θR by the polynomial described above using angles θL and θR, respectively. Here, x and y coordinates of the point P is represented by Expressions 8 and 9, respectively, below.

x=Dh*(tan θL+tan θR)/(1+(tan θL*tan θR)) Expression 8

y=−Dh*(tan θR−tan θL−(2*tan θL*tan θR))/(1+(tan θL*tan θR))+P0Y Expression 9

A pair of the sensor units 1 is changed depending on the coordinate input region 4 as described above, and parameters of the coordinate calculation formula are changed depending on the pair of sensor units 1.

For example, in a case where a calculation is performed using data detected by the sensor units 1C and 1D, Expressions 8 and 9 are performed using values illustrated in FIG. 10 while Dh is converted into Dv and P0Y is converted into P1X. Furthermore, the CPU 41 converts calculated x into y and calculated y into x.

Similarly, also in a case where light shielding data is detected by a pair of sensor units 1A and 1B and a pair of sensor units 1A and 1D, the CPU 41 performs calculations in accordance with Expressions 8 and 9 above while changing the parameters.

Some coordinate detection ranges overlap with each other in the coordinate detection available regions obtained by the pairs of sensor units 1, and therefore, the same coordinate may be detected a plurality of times. However, the CPU 41 determines a coordinate by averaging the calculated coordinate values.

Furthermore, although the coordinate input regions 4 of three planes exist in this embodiment, the CPU 41 may calculate coordinate values as described above also in a case where the calculation is performed using data detected by the sensor units 1E to 1H or 1I to 1L.

Note that coordinate values output to the PC 5 may be different depending on a display mode of the PC 5. For example, in a case of a so-called clone display in which the same image is displayed in desktop screens of the three planes, calculated coordinate values are transmitted to the PC 5 as they are. Furthermore, in a case of a so-called extension desktop mode in which images of two planes are used as one desktop screen, calculated coordinate values are preferably offset before being transmitted to the PC 5.

In this way, the calculated coordinate values may be output to the PC 5 after being offset where appropriate depending on a display mode of the PC 5, or the calculated coordinate values may be output to the PC 5 as they are. In this case, a CPU 501, described below, of the PC 5 may change the coordinate values.

### Coordinate Calculation Step

FIG. 11 is a flowchart illustrating information processing including a process from a data obtainment to a coordinate calculation. In FIG. 11, the CPU 41 of the control/calculation unit 2A performs the processing. The CPUs 41 of control/calculation units 2C and 2E also execute the process performed by the CPU 41 of the control/calculation unit 2A illustrated in FIG. 11.

In step S101, when power is on, the CPU 41 starts the process.

In step S102, the CPU 41 performs various initialization, such as a port setting and a timer setting.

In step S103, the CPU 41 sets the number of times initial reading is performed. This process is preparation for removing unnecessary charge which is performed only in boot. A photoelectric conversion element, such as a CCD sensor, may accumulate unnecessary charge while the element does not operated, and in this case, if data is used as reference data as it is, detection failure or misdetection may occur. To avoid this, reading of data is performed a plurality of times without illumination. The number of times such reading is performed is set in step S103.

In step S104, the CPU 41 reads data without illumination. Removal of unnecessary charge is performed by this process.

In step S105, the CPU 41 determines whether reading has been performed a number of times set in step S103. When it is determined that the reading has been performed a number of times set in step S103 (Yes in step S105), the process proceeds to step S106, and when it is determined that the reading has not been performed a number of times set in step S103 (No in step S105), the process in step S104 is performed again.

In step S106, the CPU 41 obtains data without illumination as reference data. This data corresponds to Bas_Data described above.

In step S107, the CPU 41 stores the obtained data in the memory 44. The data stored in the memory 44 is used in calculations to be performed thereafter.

In step S108, the CPU 41 obtains Ref_Data which is another reference data and which corresponds to an initial light amount distribution obtained when light is emitted.

In step S109, the CPU 41 stores the obtained data in the memory.

Here, the CPUs 41 of the pair of the sensor units 1 in the upper portion and the CPUs 41 of the pair of the sensor units 1 in the lower portion obtain illumination data at different timings. This is because, since the sensor units 1 on the upper portion face the sensor units 1 on the lower portion, if light is emitted at the same time, the illumination of the counterpart is detected by the light receiving unit.

In step S110, the CPU 41 determines whether the obtainment is terminated in all the sensor units 1, that is, all the sensor units 1A to 1D. When determining that the obtainment is terminated in all the sensor units 1 (Yes in step S110), the CPU 41 proceeds to step S111, whereas when determining that the obtainment is not terminated in at least one of the sensor units 1 (No in step S110), the process in step S108 and step S109 is performed again.

The process until step S110 is an initial setting operation performed when the power is on, and the following process is a normal obtaining operation.

In step S111, the CPU 41 obtains a light amount distribution as described above.

In step S112, the CPU 41 determines whether the obtainment is terminated in all the sensor units 1. When determining that the obtainment is terminated in all the sensor units 1 (Yes in step S112), the CPU 41 proceeds to step S113, whereas when determining that the obtainment is not terminated in at least one of the sensor units 1 (No in step S112), the process in step S111 is performed again.

In step S113, the CPU 41 calculates difference values between all the data and Ref_Data.

In step S114, the CPU 41 determines whether a light shielding portion exists. When it is determined that a light shielding portion exists, that is, input has been performed (Yes in step S114), the process proceeds to step S115, whereas when it is determined that a light shielding portion does not exist, that is, input has not been performed (No in step S114), the process after step S111 is performed again. Assuming that this repetition cycle is set to approximately 10 msec, sampling of 100 times/second is performed.

In step S115, the CPU 41 calculates a rate using Expression 2.

In step S116, the CPU 41 determines a rising portion and a falling portion using a threshold value for the rate obtained in step S115 and calculates a center pixel in accordance with Expressions 4, 5, and 6.

In step S117, the CPU 41 calculates tan θ from the obtained center pixel in accordance with an approximation polynomial.

In step S118, the CPU 41 selects parameters other than tan θ, such as a distance between the CCD sensors 103, in Expression 8 and 9 for the pair of the sensor units 1 in which it is determined that a light shielding region exists and changes a calculation formula.

In step S119, the CPU 41 calculates x and y coordinates using values of tan θ of the sensor units 1 using Expressions 8 and 9.

Thereafter, in step S120, the CPU 41 determines whether the coordinate calculated in step S119 has been touched. Here, the CPU 41 determines whether a proximity input state in which a cursor is moved without pressing a button of a mouse has been entered or a touch-down state in which a left button is pressed has been entered. Specifically, the CPU 41 determines that the touch-down state has been entered if a maximum value of the obtained rate is larger than a predetermined value, e.g., 0.5, and determines that the proximity input state has been entered if the maximum value is equal to or smaller than the predetermined value. When determining that the touch-down state has been entered (Yes in step S120), the CPU 41 proceeds to step S121 whereas when determining that the proximity input state has been entered (No in step S120), the CPU 41 proceeds to step S122.

The CPU 41 sets a down flag in step S121.

On the other hand, the CPU 41 cancels the down flag in step S122.

In step S123, the CPU 41 transmits the coordinate value and information on the down state to the PC 5. The CPU 41 may transmit the data and the like to the PC 5 by a serial communication, such as a USB or RS232, or an arbitrary interface. In the PC 5 which has received the data, the CPU 501, described below, of the PC 5 interprets the data, moves the cursor, and changes a state of the mouse button, for example, with reference to the coordinate value, the flag, and the like. By this, an operation on a PC screen is enabled.

When the process in step S123 is terminated, the CPU 41 returns to the process in step S111, and thereafter, repeatedly performs the process described above until the power is turned off.

### Calibration

Calibration means adjustment of display of a cursor in a position finally touched in a certain operation under control of the PC 5. Therefore, parameters for converting a coordinate system of the coordinate input apparatus into a display coordinate system of an operating system are obtained or an operator is prompted to perform a series of operations so that parameters for converting a coordinate system of the coordinate input apparatus into a display coordinate system of an operating system are obtained. Then a state in which the converted coordinate value is allowed to be output such that a cursor is finally displayed in a touched position is entered.

Input of the coordinate input apparatus and display of the PC 5 are configured by different coordinate systems. Hereinafter, a coordinate system of the coordinate input apparatus and a PC coordinate system (display) will be described. The different coordinate input apparatuses configure different coordinate systems by measuring positional relationships of the sensors 103 when power is turned on. Then, the coordinate input apparatuses detect a touch position in the respective coordinate systems and output coordinate data. The CCD sensors 103 of the coordinate input apparatuses are not precisely disposed at regular intervals, and therefore, it is not necessarily the case that absolute values of coordinate values output from the coordinate input apparatuses are the same.

Hereinafter, the calibration in this embodiment will be described.

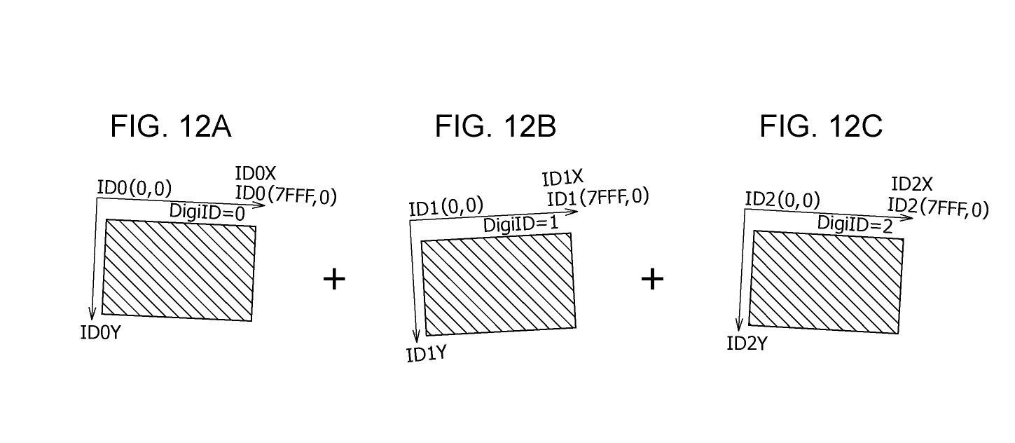

FIGS. 12A to 12C are diagrams schematically illustrating the coordinate systems of the coordinate input apparatuses. The coordinate input apparatuses form respective coordinate systems and independently perform output of data, such as coordinates or events. Therefore, it is not necessarily the case that the coordinate systems formed by the coordinate input apparatuses have the same inclination, that is, the coordinate systems may have different inclinations. Specifically, in a coordinate system in a case of the coordinate input apparatus having an identification (ID) DigiID of 0, a coordinate value in a range from ID0(0, 0) to ID0(7FFF, 7FFF) is output as a coordinate value in an ID0X axis and an ID0Y axis. The same is true of cases of coordinate input apparatuses having an ID DigiID of 1 and an ID DigiID of 2.

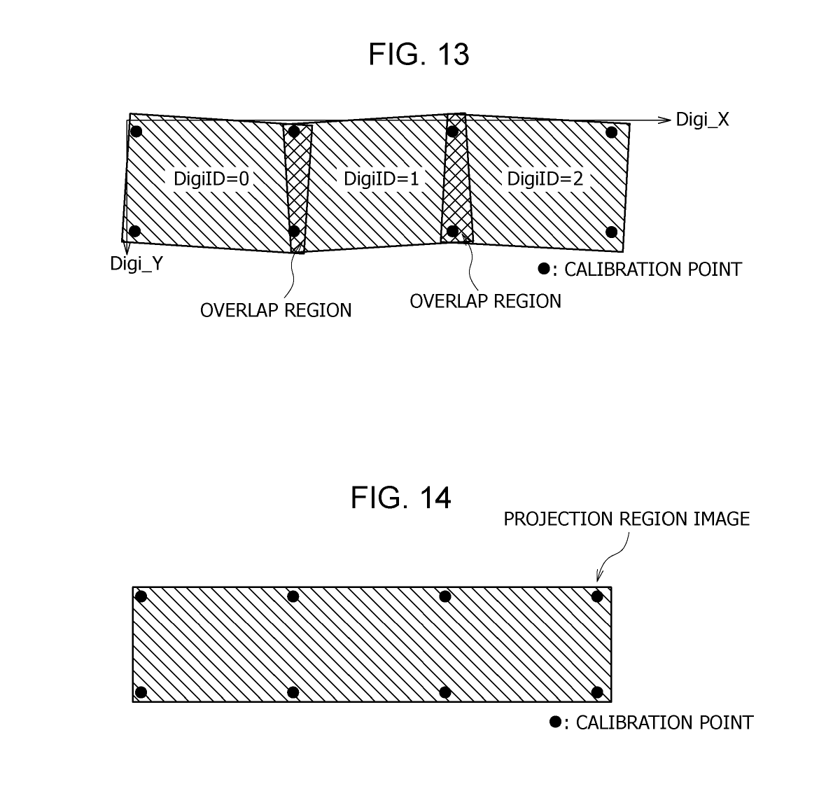

FIG. 13 is a diagram schematically illustrating a case where the independent coordinate systems illustrated in FIGS. 12A to 12C are arranged such that the coordinate input regions 4 form overlap regions. Here, the overlap regions indicate regions in which the coordinate input regions 4 overlap with each other. In FIG. 13, the overlap regions are denoted by cross hatching.

Furthermore, coordinate conversion in the coordinate input regions 4 is performed on coordinate systems newly formed using coordinate values of four points obtained as calibration points. The calibration points have been obtained as display positions of the PC 5. The CPU 501, described below, of the PC 5 stores a touched position and performs coordinate conversion by inputting a detected coordinate in a predetermined coordinate conversion function so that the touched position matches a display position (cursor) of the PC 5. Here, the four calibration points are obtained in each coordinate input region. Specifically, as illustrated in FIG. 13, two of four calibration points of the coordinate input apparatus having the ID DigiID of 0 are included in an overlap region between the coordinate input apparatus having the ID DigiID of 0 and the coordinate input apparatus having the ID DigiID of 1. The coordinate input apparatus having the ID DigiID of 1 has four calibration points included in overlap regions. As with the coordinate input apparatus having the ID DigiID of 0, two of four calibration points of the coordinate input apparatus having the ID DigiID of 2 are included in an overlap region between the coordinate input apparatus having the ID DigiID of 1 and the coordinate input apparatus having the ID DigiID of 2. Furthermore, in this state, as illustrated in FIG. 13, a Digi_X axis and a Digi_Y axis are formed as coordinate axes of a coordinate system which incorporates effective areas of all the coordinate input regions 4.

FIG. 14 is a diagram schematically illustrating a display coordinate system displayed in a display device as a desktop screen of the operating system of the PC 5. In a case where the display device is a projector, a projection region image is displayed, and calibration points are located in positions the same as those illustrated in FIG. 13. Specifically, coordinate values detected by the coordinate input apparatuses when the user touches the calibration points displayed as a projection image correspond to the calibration points illustrated in FIG. 13.

The calibration process of this embodiment includes first and second steps. In the first step, when four corners of the projection image are touched, the CPU 501, described below, of the PC 5 recognizes a projection region projected by the projector on a digitizer coordinate detection region. Thereafter, the CPU 501, described below, of the PC 5 calculates calibration points in a PC display coordinate system using coordinate data detected by the touch such that the points are displayed in overlap regions. The positional relationship between the sensor units 1 and digitizers are substantially as designed. In the second step, the CPU 501, described below, of the PC 5 displays the calibration points calculated in the first step and obtains coordinate data when the calibration points are touched in turn. Thereafter, the CPU 501, described below, of the PC 5 sets parameters for calibration calculation (coordinate system conversion).

FIG. 15 is a diagram illustrating a hardware configuration of the PC 5. The PC 5 includes the CPU 501, a read only memory (ROM) 502, a random-access memory (RAM) 503, a secondary storage device 504, an input device 505, the display device 506, a network interface (I/F) 507, and a bus 508.

The CPU 501 executes commands in accordance with programs stored in the ROM 502 and the RAM 503.

The ROM 502 is a nonvolatile memory and stores programs, data, and the like used when the CPU 501 executes processes in accordance with the programs.

The RAM 503 is a volatile memory which stores temporary data, such as frame image data and a pattern determination result.

The secondary storage device 504 is a rewritable secondary storage device, such as a hard disk drive or a flash memory, which stores image information, image processing programs, various setting content, and the like. The information is transferred to the RAM 503 and used when the CPU 501 executes a process in accordance with a program.

The input device 505, such as a keyboard or a mouse, notifies the CPU 501 of input performed by the user.

The display device 506, such as a projector or a liquid crystal display, displays a processing result and the like of the CPU 501, such as the projection region image illustrated in FIG. 14. The display device 506 may be an external device of the PC 5.

The network I/F 507, such as a modem or a local area network (LAN), performs connection to a network, such as the Internet or an intranet.

The bus 508 is used to connect these devices so that data is input to and output from each other.

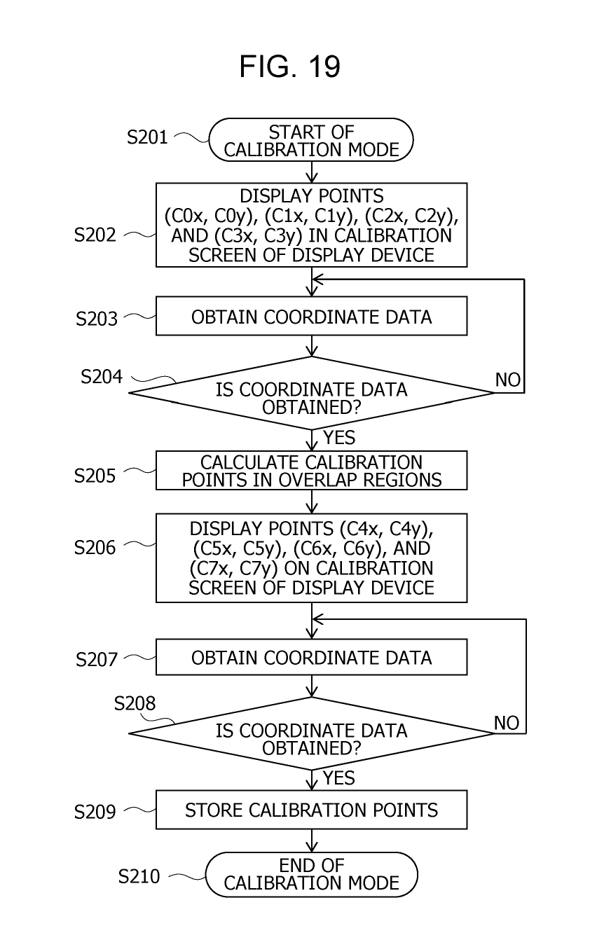

The CPU 501 executes a process in accordance with a program stored in the ROM 502 or the secondary storage device 504 so as to realize functions of the PC 5 serving as an information processing apparatus and a process in the steps of the PC 5 in a flowchart in FIG. 19.

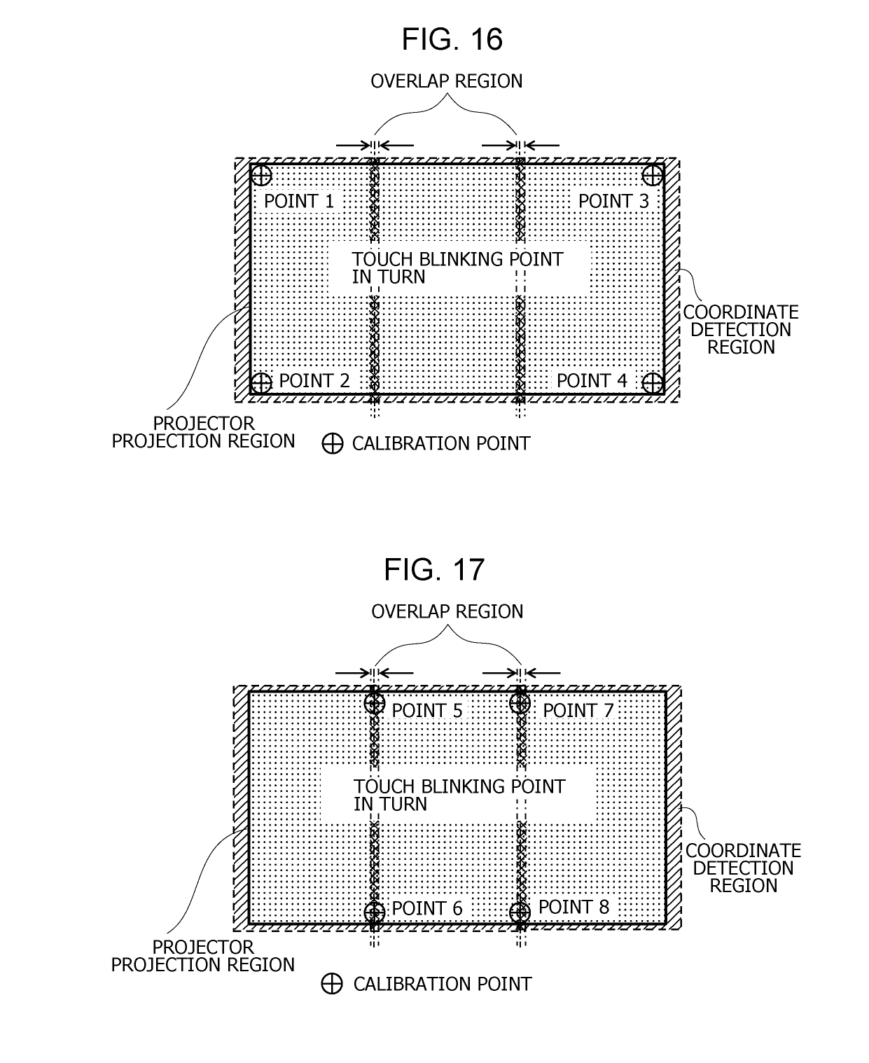

FIGS. 16 and 17 are diagrams illustrating the processes of the first and second steps of the calibration process described above, respectively. As illustrated in FIGS. 16 and 17, the user performs input in accordance with a cursor point and a message displayed in a screen.

As illustrated in FIG. 16, in the first step of the calibration process, the CPU 501 displays points 1 to 4 as calibration points which are predetermined positions in a coordinate system of a desktop. Then the user touches the blinking calibration points in turn. By this, the CPUs 41 of the coordinate input apparatuses detect coordinate values.

Although the positions of the calibration points illustrated in FIG. 16 are predetermined positions, calibration points illustrated in FIG. 17 are calculated in accordance with the coordinate values obtained in the first step of the calibration process illustrated in FIG. 16.

As illustrated in FIG. 17, in the second step of the calibration process, the CPU 501 displays points 5 to 8. As described above, when the points 1 to 4 illustrated in FIG. 16 are detected, the CPU 501 displays points in overlap regions of the coordinate input regions 4. The user touches the blinking calibration points 5 to 8 in turn. By this, the CPUs 41 of the coordinate input units detect coordinate values.

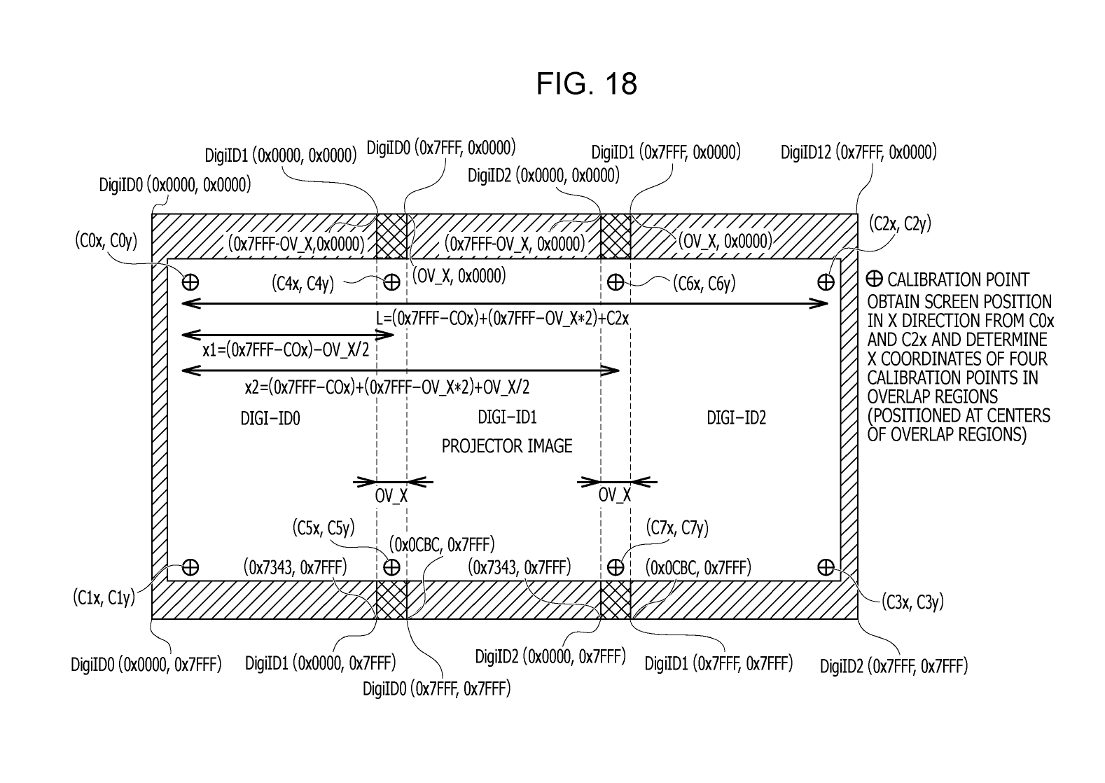

FIG. 18 is a diagram illustrating a calculation of the calibration points 5 to 8 of FIG. 17.

In FIG. 18, assuming that the point 1 of FIG. 16 is denoted by “(c0x, c0y)” and the point 3 of FIG. 16 is denoted by “(c2x, c2y)”, a distance L between c0x and c2x is represented as follows.

L=(0x7FFF−C0x)+(0x7FFF−OV_X*2)+C2x

Here, “OV_X” denotes a width of overlap regions.

Assuming that the point 5 of FIG. 17 is denoted by “(c4x, c4y)” and the point 7 of FIG. 17 is denoted by “(c6x, c6y)”, a value of c4x is x1 in FIG. 18 and represented as follows.

x1=(0x7FFF−C0x)−OV_X/2

Furthermore, a value of c6x is x2 in FIG. 18 and represented as follows.

x2=(0x7FFF−C0x)+(0x7FFF−OV_X*2)+OV_X/2

In this embodiment, “c0y”, “c2y”, “c4y”, and “c6y” are the same predetermined value. Similarly, “c1y”, “c3y”, “c5y”, and “c7y” are the same predetermined value. Furthermore, “c4x=c5x” and “c6x=c7x” are satisfied.

The calibration process described above is performed by the PC 5 in a calibration mode. The calibration mode is executed as an application realized when the CPU 501 executes a process in accordance with a program and is activated by the user using a GUI or the like. FIG. 19 is a flowchart illustrating information processing associated with the calibration.

In step S201, the CPU 501 starts a process in the calibration mode.

In step S202, the CPU 501 displays a cursor in points (C0x, C0y), (C1x, C1y), (C2x, C2y), and (C3x, C3y) in predetermined positions on a calibration screen of the display device 506. The user touches the points in turn in accordance with a menu.

In step S203, the CPU 501 obtains coordinate data.

In step S204, the CPU 501 determines whether coordinate data for the four points has been obtained. When the coordinate data for the four points has been obtained, the CPU 501 proceeds to step S205, and otherwise, the CPU 501 performs the process from step S203 again.

In step S205, the CPU 501 calculates calibration points of the overlap regions using the obtained data.

In step S206, the CPU 501 displays a cursor in the points of the overlap regions calculated in step S205, that is, points (C4x, C4y), (C5x, C5y), (C6x, C6y), and (C7x, C7y), in the calibration screen of the display device 506. The user touches the points in turn in accordance with a menu.

In step S207, the CPU 501 obtains coordinate data. The coordinate detection is performed on the coordinate input regions 4 for the individual points, and therefore, two coordinates are detected for one point and obtained by the CPU 501.

In step S208, the CPU 501 determines whether coordinate data for the eight points has been obtained. When the coordinate data for the eight points has been obtained, the CPU 501 proceeds to step S209, and otherwise, the CPU 501 performs the process from step S207 again.

In step S209, the CPU 501 stores the coordinate data of the obtained 12 calibration points.

When the storage process is terminated, the CPU 501 terminates the process in the calibration mode in step S210.

As described above, the coordinate data of the four calibration points for each coordinate input region 4 may be obtained and used for coordinate conversion of the coordinate input regions 4. Consequently, even in a system having a large screen coordinate input region formed by connecting and combining a plurality of coordinate input apparatuses, positioning between an instruction position and a display image may be more easily performed by reducing the number of calibration points by displaying the calibration points particularly in joining portions (overlap regions).

Although the coordinate input apparatuses employing the light shielding method have been described in this embodiment, the method is not limited to the light shielding method. The process of this embodiment is effective even in a case where a method of performing image processing using a camera is employed in a configuration in which the coordinate input regions 4 have overlap regions.

### Second Embodiment

In the first embodiment, the display of the calibration points and the process of integrating coordinate data of the coordinate input apparatuses are executed by an application realized when the CPU 501 executes a program.

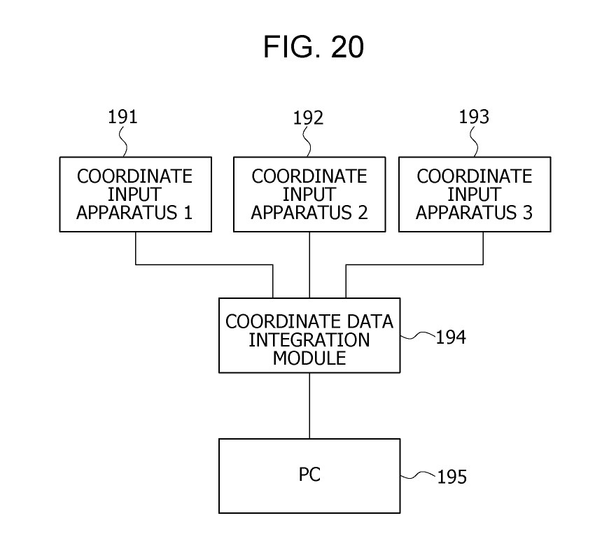

In this embodiment, a case where a module which performs a process of integrating coordinate data is configured will be described. FIG. 20 is a diagram illustrating a configuration of a system according to a second embodiment. Coordinate input apparatuses 191 to 193 are connected to a coordinate-data integration module 194. Furthermore, the coordinate-data integration module 194 is connected to a PC 195 having the hardware configuration illustrated in FIG. 15.

The coordinate-data integration module 194 includes a CPU having a function of serial communication, such as a USB, and a memory, and is capable of communicating with the coordinate input apparatuses 191 to 193 and the PC 195. A USB host function is used for communication with the coordinate input apparatuses 191 to 193, and a USB device function is used for communication with the PC 195. With this configuration, it appears that one device, that is, the coordinate-data integration module 194, is connected to the PC 195 as a USB device when viewed from the PC 195.

Furthermore, the coordinate-data integration module 194 receives IDs of the coordinate input apparatuses 191 to 193, detection coordinates, detection coordinate IDs, and various event information from the coordinate input apparatuses 191 to 193 through communication. Furthermore, in the calibration mode described above, the coordinate-data integration module 194 stores values of calibration points, a range information of overlap regions, and the like in a memory. The coordinate-data integration module 194 performs a process of assigning an integrated ID to a coordinate value as if detection coordinates of the coordinate input apparatuses 191 to 193 are output from one device as an entire region including overlap regions and other regions, and transmits the integrated ID to the PC 195.

With this configuration, if the calibration is performed in a system initial setting, the coordinate integration process of the coordinate input apparatuses by the application of the PC 195 is not needed in a normal use state, and therefore, utilization of the CPU 501 may be reduced.

### Third Embodiment

In FIG. 1, the CPU 501 appropriately selects the plurality of coordinate values detected by the coordinate input apparatuses using the calibration points in the overlap regions as boundaries.

In this embodiment, a case where the CPU 501 performs an averaging process on coordinate data detected by coordinate input apparatuses in a range of overlap regions of coordinate input regions 4 will be described.

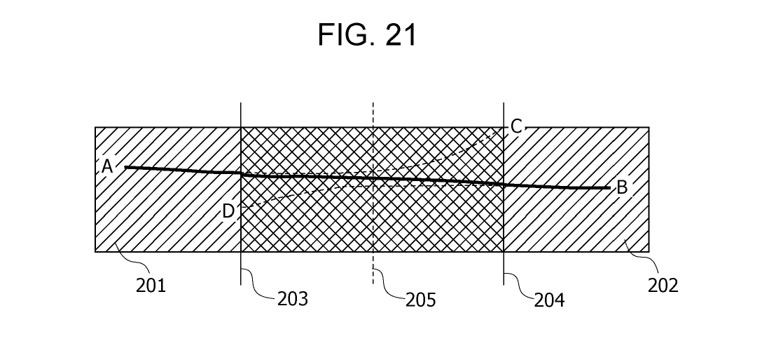

FIG. 21 is a diagram illustrating a process of this embodiment of the present disclosure. Portions of coordinate input regions 201 and 202 are displayed in an enlarged manner. Then, a detection range 204 of the coordinate input region 201 and a detection range 203 of a coordinate input region 202 are disposed so as to overlap with each other as illustrated in FIG. 21. A line 205 denotes a Y direction of calibration points.

Here, in a case where input is performed in a range from A to B as illustrated in FIG. 21, coordinates are detected such that a line from A to C curves toward a detection region end portion in the coordinate input region 201. This occurs due to an error, such as a deviation of a light receiving lens, in the sensor units 1 described above. Similarly, coordinates are detected as illustrated by a line from D to B in the coordinate input region 202.

In this case, if the coordinate input regions are switched from one to another in a Y direction of the calibration points as with the first embodiment, a trajectory of rendering has steps more or less.

In this embodiment, in an overlap region, the CPU 501 performs an averaging process on coordinate values detected in the coordinate input regions so that the trajectory is rendered as denoted by a bold line in FIG. 21.

The CPU 501 performs the averaging process on a detection range 203 so that coordinate values of the coordinate input region 202 are weighted by one and performs the averaging process on the detection range 204 so that coordinate values of the detection range 203 are weighted by one. Furthermore, the CPU 501 performs a process of performing weighting by ½ on the coordinate values of both of the detection ranges 203 and 204 in the line 205 along the Y direction of the calibration points.

The CPU 501 determines a coefficient value of the weighting in the range of the overlap region as described below. Specifically, the CPU 501 uses coordinate values in the coordinate input region 202 in a range between the detection range 203 and the line 205 so as to calculate a position in an X direction of the range of the overlap region, and as described above, determines a coefficient such that a rate of 1 and a rate of 0.5 are obtained in the detection range 203 and the line 205, respectively. Similarly, the CPU 501 uses coordinate values in the coordinate input region 201 in a range between the line 205 to the detection range 204, and determines a coefficient such that a rate of 1 and a rate of 0.5 are obtained in the detection range 204 and the line 205, respectively. By this process, a smooth trajectory indicated by a bold line from A to B is rendered.

As described above, according to this embodiment, errors of coordinate values to be output may be reduced even if errors are generated in end portions of coordinate input regions.

### OTHER EMBODIMENTS

The present disclosure may be realized by supplying a program having at least one of the functions of the foregoing embodiments to a system or an apparatus through a network or a storage medium and reading and executing the program using at least one processor included in a computer of the system or the apparatus. Furthermore, the present disclosure may be realized by a circuit (ASIC, for example) which realizes at least one of the functions.

Specifically, embodiments of the present disclosure can be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Although the preferred embodiments of the present disclosure have been described in detail hereinabove, the present disclosure is not limited to the specific embodiments. The embodiments described above may be arbitrary combined with each other.

According to the foregoing embodiments, accuracy of joining portions (overlap regions) may be maintained and positioning between selected positions and display positions may be enabled with ease.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2015-160601, filed Aug. 17, 2015, which is hereby incorporated by reference herein in its entirety.

What is claimed is:

1. An information processing apparatus comprising:
a display processing unit configured to display a first point on a display screen of a display device;
a first obtaining unit configured to obtain first coordinate data based on the first point displayed on the display screen by the display processing unit from a plurality of coordinate input apparatuses having an overlap region in which coordinate detection regions of the coordinate input apparatuses overlap with each other;
a second obtaining unit configured to obtain, in a case where a second point is displayed in a position corresponding to the overlap region on the display screen by the display processing unit based on the first coordinate data, second coordinate data in accordance with an instruction of the second point from the plurality of coordinate input apparatuses; and
a positioning unit configured to perform positioning between a selection position and a display position in accordance with the first coordinate data and the second coordinate data.

2. The information processing apparatus according to claim 1, wherein the display processing unit displays the first point in a position corresponding to a region outside the overlap region on the display screen.

3. The information processing apparatus according to claim 1,
wherein the first obtaining unit obtains the first coordinate data based on the first point from an integration apparatus which integrates coordinate data and which are connected to the plurality of coordinate input apparatuses, and
the second obtaining unit obtains the second coordinate data based on the second point from the integration apparatus.

4. The information processing apparatus according to claim 1, further comprising:
a controller configured to perform an averaging process on the second coordinate data,
wherein the positioning unit performs positioning between a selection position and a display position in accordance with the first coordinate data and the second coordinate data which has been subjected to the averaging process.

5. An information processing method executed by an information processing apparatus, the method comprising:
displaying a first point on a display screen of a display device;
obtaining first coordinate data detected based on the displayed first point from a plurality of coordinate input apparatuses having an overlap region in which coordinate detection regions of the coordinate input apparatuses overlap with each other;
displaying a second point in a position corresponding to the overlap region on the display screen based on the first coordinate data;
obtaining second coordinate data based on the displayed second point from the plurality of coordinate input apparatuses; and
performing positioning between a selection position and a display position in accordance with the first coordinate data and the second coordinate data.

6. A non-transitory storage medium which stores a program for executing an information processing method, the method comprising:
displaying a first point on a display screen of a display device;
obtaining first coordinate data based on the displayed first point from a plurality of coordinate input apparatuses having an overlap region in which coordinate detection regions of the coordinate input apparatuses overlap with each other;
displaying a second point in a position corresponding to the overlap region on the screen based on the first coordinate data;
obtaining second coordinate data detected based on the displayed second point from the plurality of coordinate input apparatuses; and
performing positioning between a selection position and a display position in accordance with the first coordinate data and the second coordinate data.
